(19) United States
(12) Patent Application Publication
(10) Pub. No.: US 2014/0202424 A1
(43) Pub. Date: Jul. 24, 2014

(54) Variable throttle device

(71) Applicant: JIANGSU GONGDA POWER TECHNOLOGIES CO., LTD., Changshu (CN)

(72) Inventors: Zheng LOU, Plymouth, MI (US); Shao WEN, Changshu (CN); Qiangquan DENG, Changshu (CN); Mengjin YU, Changshu (CN)

(73) Assignee: JIANGSU GONGDA POWER TECHNOLOGIES CO., LTD., Changshu (CN)

(21) Appl. No.: 14/160,583

(22) Filed: Jan. 22, 2014

(30) Foreign Application Priority Data
Jan. 24, 2013 (CN) 201310026828.X

(51) Int. Cl. F02D 9/02

(52) U.S. Cl. CPC F02D 9/02
USPC 123/336

(57) ABSTRACT

A variable throttle device comprises at least two fixed throttle orifices and one switch device. The at least two fixed throttle orifices are connected in series; and the switch device is connected in parallel with at least one of the at least two fixed throttle orifices. In another implementation, a variable throttle device comprises at least two throttle passages and one switch device, each of the at least two throttle passages has at least one fixed throttle orifice or a plurality of fixed throttle orifices connected in series, the at least two throttle passages are connected in parallel, and the switch device is connected in series with at least one of the at least two throttle passages to selectively open or close the at least one throttle passage. The variable throttle device can increase or decrease the throttling resistance to meet the requirements of the valve seating velocity under different operating conditions.

### REFERENCE TO RELATED APPLICATION

This application claims the priority of the Chinese patent application of serial no. 201310026828.X, filed on Jan. 24, 2013, and the entire content of both of which is incorporated herein by reference.

### FIELD OF THE INVENTION

The present disclosure relates to a variable throttle device, and its applications include engine variable valve actuation systems.

### BACKGROUND OF THE INVENTION

The valve seating velocity refers to the velocity of a valve at the instant when the valve is closed. Generally, in order to meet the low-noise requirement, the seating velocity of an automobile gasoline engine valve shall not exceed 0.05 m/s at an idling speed; and in order to meet the requirement of service life, the seating velocity of an automobile gasoline engine valve shall not exceed 0.5 m/s at the top speed. For diesel engines, the valve seating velocity is generally required not to exceed 0.3 m/s.

Generally speaking, the valve seating velocity shall be insensitive to the temperature. Meanwhile, it is expected that the valve seating velocity shall be controlled in a certain manner so that the valve seating velocity increases with the engine speed within the limit of the top speed. The purpose of increasing the valve seating velocity at high rotation speeds is to indirectly shorten the seating time so as to ensure an adequate time window for air intake and exhaust.

According to conventional actuator control technologies, throttle orifices have the following types of structures: the needle valve orifice, the eccentric orifice, the axial triangle groove orifice, the circumferential orifice, the axial aperture orifice and so on. If a precise throttling effect is required and the flow is relatively small, usually a hole structure (especially a circular hole) is adopted. An orifice is called a sharp edge orifice when a length-to-diameter ratio thereof is less than 0.5, is called a long orifice when a length-to-diameter ratio thereof is greater than 4, and is called a short orifice when a length-to-diameter ratio thereof ranges between 0.5 and 4. When a liquid flows through the sharp edge orifice, liquid from a larger diameter part will converge towards the opening of the orifice. Because the stream lines cannot change their flow directions suddenly at the orifice, a so-called shrinking phenomenon will take place; and then the stream lines become diverged again. This leads to a considerable energy loss. The extent to which the liquid flow shrinks depends on such factors as the Reynolds number (Re), the shape of the orifice opening and its edge, and the distance from the orifice opening to the inner wall of the throttle orifice.

Accordingly, the throttle orifice in the engine valve controller is required to be a sharp edge orifice that is insensitive to the temperature, is variable, and has a very small orifice diameter at the maximum throttling level if a single throttle orifice is used (which challenges the limit of fabrication process or that of resistance to contaminants). Meanwhile, variability of the throttle orifice shall be achieved by a simple and stable structure.

However, some variable throttle orifice is achieved by some proportional control technology in the prior art, and this is disadvantageous in terms of both cost and stability. FIG. 1 shows a schematic structural view of an engine valve control system that uses a variable throttle orifice in the prior art. The engine valve shown in FIG. 1 is in a process of being closed. The valve control system comprises an actuator body 21, a spring system 70 and an engine valve 80. The body 21 has the following disposed therein and along a longitudinal axis from top to bottom as viewed in this figure: a first passage 22, a cylinder 23, an upper port 24, a lower port 25, and a piston rod bore 26. The valve control system further comprises a piston 30 disposed inside the cylinder 23, and a piston rod 60 disposed in the piston rod bore 26 and connected integrally or rigidly with the piston 30.

The cylinder 23 comprises a cylinder upper chamber 232 defined by a first end 231 of the cylinder 23 and a first surface 306 of the piston 30 and a cylinder lower chamber 234 defined by a second end 233 of the cylinder 23 and a second surface 307 of the piston 30. The upper port 24 connects to an output port 41 (or termed as a work port or A port) of a switch valve 40. The switch valve 40 is a two-position three-way valve and, when staying in its position or operation state as shown in this figure, allows the cylinder upper chamber 232 to discharge oil to a tank 50. The lower port 25 connects to a low-pressure pipe PL.

The spring system 70 comprises a valve spring retainer 71, a valve return spring 72, a valve guide 73 and an engine cylinder head block 74. The valve spring retainer 72 connects with an end of the valve stem 81, and the other end of the valve stem 81 connects with the engine valve head 82. The engine cylinder head block 74 is located between the valve spring retainer 71 and the engine valve head 82, the valve guide 73 is fitted through the engine cylinder head block 74, and the valve stem 81 extends through the valve guide 73. The valve return spring 72 is fitted over the valve stem 81 and makes contact both with the engine cylinder head block 74 and the valve spring retainer 71. The piston 30 and the engine valve 80 tend to move upward under the action of the valve return spring 72.

The valve control system further comprises a snubber formed by a check valve 11 and a variable throttle orifice 12. As shown in FIG. 1, an end of the snubber can connect to the cylinder upper chamber 232 via the first passage 22; alternatively, the check valve 11 and the variable throttle orifice 12 may also connect with the cylinder upper chamber 232 separately and directly (not shown). The other end of the snubber can connect to the upper port 24 or the output port 41 of the switch valve 40 as shown in FIG. 1. The check valve 11 is disposed to ensure that the oil can only flow into the cylinder upper chamber 232 unidirectionally to allow for quick opening. In the valve control system, the variable throttle orifice 12 functions to adjust the throttling level so as to adjust the throttle resistance. Typically, the variable throttling orifice 12 is an aperture having an adjustable sectional area or a valve port having an adjustable opening.

Additionally, continuously adjustable throttle orifices or valve ports either operate unstably or have high costs due to their complex structures or high precision.

### SUMMARY OF THE INVENTION

In view of the aforesaid problems, an objective of the present disclosure is to provide a variable throttle device which can provide ideal valve seating velocities at different operating conditions.

The present disclosure provides a variable throttle device, which comprise at least two fixed throttle orifices and one switch device. The at least two fixed throttle orifices are connected in series; and the switch device is connected in parallel with at least one of the at least two fixed throttle orifices so that the switch device can be selectively closed and opened respectively to maintain and bypass the throttling function of the at least one of the at least two fixed throttle orifices.

The present disclosure further provides a variable throttle device, which comprises at least two throttle passages and one switch device. Each of the at least two throttle passages has at least one fixed throttle orifice or a plurality of fixed throttle orifices connected in series; the at least two throttle passages are connected in parallel; and the switch device is connected in series with one of the at least two throttle passages, thereby selectively opening and closing the one of the at least two throttle passages.

In an embodiment of the present disclosure, the variable throttle device comprises a base body; the switch device comprises a first passage, a second passage, a control port and a valve spool disposed within the base body; the valve spool has a control-side surface and a switch-side surface; the valve spool is disposed in a space that communicates with the first passage, the second passage and the control port; the switch-side surface of the valve spool is disposed to face toward one of the first passage and the second passage, and the control-side surface of the valve spool is disposed to face toward the control port.

In an embodiment of the present disclosure, the valve spool is disposed vertically to facilitate opening of the switch device by the gravity of the valve spool.

In an embodiment of the present disclosure, the fixed throttle orifices include throttle orifice units.

In an embodiment of the present disclosure, the throttle orifice units comprise sheets with throttle orifices.

In an embodiment of the present disclosure, a gasket is sandwiched between every two adjacent ones of the sheets, and the gaskets have an outer diameter equal to that of the sheets and an inner diameter much greater than the throttle orifices.

In an embodiment of the present disclosure, the fixed throttle orifices have a diameter ranging between 0.50 mm and 1.0 mm.

By connecting throttle passages or variable throttle orifices in parallel or in series and in combination with the use of the switch device, the variable throttle device of the present disclosure can increase or decrease the throttle resistance to meet the requirements of the valve seating velocity at different operating conditions.

What has been described above is only a summary of the technical solutions of the present disclosure. In order to provide a better understanding of the technical means of the present disclosure so that the present disclosure can be practiced according to this description and in order to make the aforesaid and other objectives, features and advantages of the present disclosure more apparent, the present disclosure will be detailed herein below with reference to embodiments thereof in conjunction with the attached drawings.

### BRIEF DESCRIPTION OF THE DRAWINGS

FIG. 1 is a schematic structural view of an engine valve control system in the prior art;

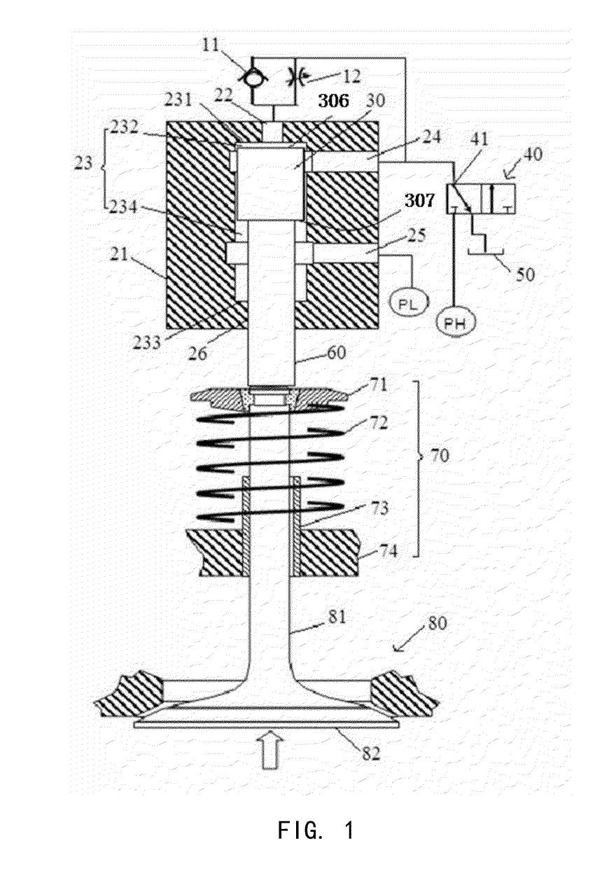

FIG. 2 is a schematic view of a variable throttle device according to a first embodiment of the present disclosure;

FIG. 3 is a schematic view of a variable throttle device according to a second embodiment of the present disclosure;

FIG. 4 is a schematic view of a variable throttle device according to a third embodiment of the present disclosure;

FIG. 5 is a schematic view of a variable throttle device according to a fourth embodiment of the present disclosure;

FIG. 6 is a schematic structural view of the variable throttle device shown in FIG. 4;

FIG. 7 is another schematic structural view of the variable throttle device shown in FIG. 4; and

FIG. 8 is a schematic structural view of the fixed throttle orifices shown in FIG. 3 to FIG. 4 when being connected in series.

### DETAILED DESCRIPTION OF THE INVENTION

Herein below, preferred embodiments of the present disclosure will be detailed with reference to the attached drawings so that advantages and features of the present disclosure can be better understood by those skilled in the art. However, the scope of the present disclosure is not limited to these embodiments.

The variable throttle device of the present disclosure achieves the effect of a variable throttle orifice in the following way. In design, a smaller orifice results in a greater flow resistance or a higher throttle level, but too small of an orifice would be clogged by pollutants, thus affecting the normal operation. In a hydraulic system, it is preferred that the orifice is greater than 0.5 mm or 1.0 mm. If an adequate throttle level cannot be provided by a single orifice, which shall not be made too small, a plurality of orifices may be used in series to provide a superimposed resistance.

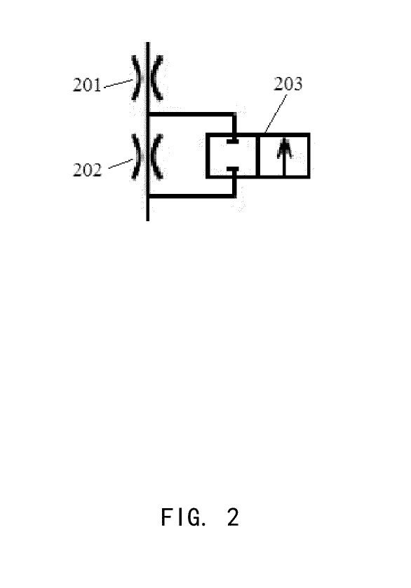

Referring to FIG. 2, in a first embodiment, the variable throttle device comprises two fixed throttle orifices 201, 202 connected in series and a switch device 203. The switch device 203 is connected parallel to the fixed throttle orifice 202. Relative to the fixed throttle orifices, the switch device 203 has, when it is open, a smaller resistance to fluid flow. In FIG. 2, the switch device 203 is in a closed state, and the fluid must flow through two fixed throttle orifices 201, 202 in sequence to experience a superimposed throttle effect. On the other hand, when the switch device 203 is in an opened state, then the resistance it provides is much smaller than that provided by the fixed throttle orifice 202, so the fluid preferentially flows through the switch device 203 and therefore, the fixed throttle orifice 202 is bypassed. As a result, the effective throttle resistance can be reduced to increase the engine valve seating velocity. This is desired when the engine operates at a high speed. In an alternative embodiment, the switch device 203 is connected parallel to the fixed throttle orifice 201. In other embodiments, there may be three or more fixed throttle orifices (not shown) connected in series, with one of the fixed throttle orifices being connected parallel to the switch device.

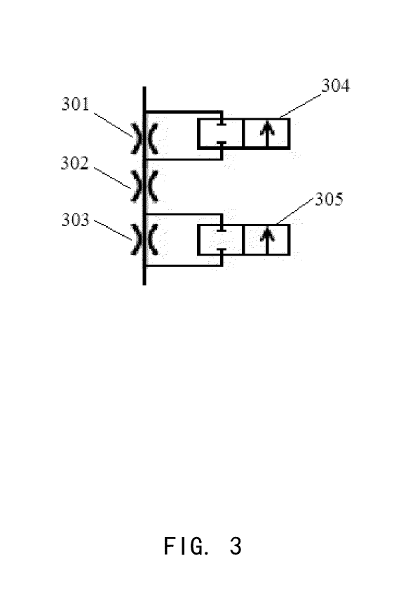

Referring to FIG. 3, in a second embodiment, the variable throttle device comprises three fixed throttle orifices 301, 302 and 303 connected in series, and switch devices 304, 305. The switch devices 304, 305 are connected parallel to two of the fixed throttle orifices 301, 303. When the switch devices 304, 305 are both in the closed state, the fluid must flow through the three fixed throttle orifices 301, 302, 303 in sequence to experience a superimposed effect of the three throttle orifices. This is equivalent to an effect of three effective throttle orifices, with the throttle effect being the maximum and the flow rate passing there through being the least. When one of the switch devices 304, 305 (e.g., the switch device 304) is in the opened state, one of the fixed throttle orifices (e.g., the fixed throttle orifice 301) is bypassed, so the whole variable throttle device now has two effective throttle orifices; and in this case, both the throttle effect and the flow rate passing therethrough are at a medium level. When the switch devices are both in the opened state, the fixed throttle orifices 301, 303 are both bypassed, so there is only one effective fixed throttle orifice (i.e., the fixed throttle orifice 302); and in this case, the throttle effect is at the lowest level but the flow rate passing therethrough is the greatest. In other embodiments, the two switch devices 304, 305 may also be connected in parallel with two fixed throttle orifices 301, 302 respectively (not shown), or with two fixed throttle orifices 302, 303 respectively (not shown).

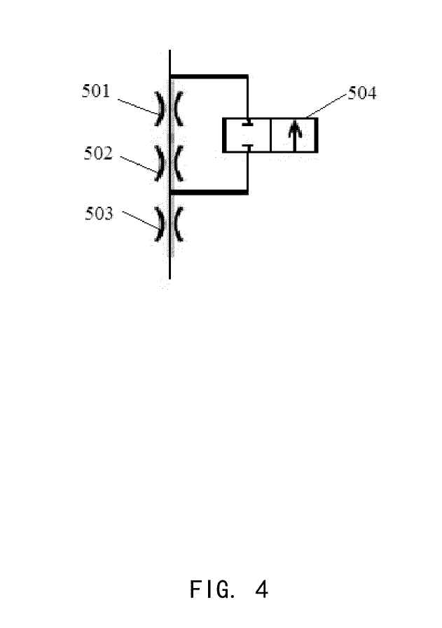

Referring to FIG. 4, in a third embodiment, the variable throttle device comprises three fixed throttle orifices 501, 502, 503 connected in series and one switch device 504. The switch device 504 is connected parallel to a combination of two of the fixed throttle orifices 501, 502. When the switch device 504 is in the closed state, all the three fixed throttle orifices 501, 502, 503 are opened; and when the switch device 504 is in the opened state, the fixed throttle orifices 501, 502 are bypassed. In other embodiments, the switch device 504 may also be connected parallel to a combination of the two fixed throttle orifices 502, 503 (not shown). In other embodiments, there may also be four or more fixed throttle orifices connected in series (not shown), and the switch device 504 may be connected in parallel to a combination of two of more of the fixed throttle orifices.

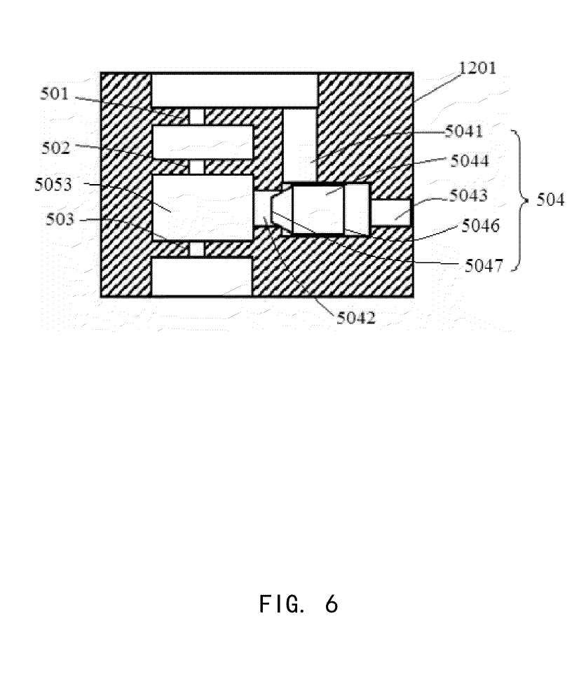

Referring to FIG. 4 and FIG. 6 together, a detailed structure of the variable throttle device shown in FIG. 4 is as shown in FIG. 6. The fixed throttle orifices 501, 502, 503 are formed in a base body 1201 of the variable throttle device in series from top to bottom as viewed in these figures. The switch device 504 comprises a first passage 5041, a second passage 5042, a control port 5043 and a valve spool 5044. The valve spool 5044 has a control-side surface 5046 and a switch-side surface 5047. The second passage 5042 connects to a portion between the fixed throttle orifices 502, 503. The first passage 5041 connects to an end of the fixed throttle orifice 501 that is away from the fixed throttle orifice 502. The valve spool 5044 is disposed in a space that communicates with the first passage 5041, the second passage 5042 and the control port 5043. The control port 5043 is used to provide a control pressure onto the control-side surface 5046 to drive the valve spool 5044. In FIG. 6, the valve spool 5044 is disposed in a left-right direction (i.e., in a horizontal direction), and the control port 5043 is formed on a right-side surface of the base body 1201. In this figure, the valve spool 5044 is in the closed state, and when no pressure is provided from the control port, the valve spool 5044 may be returned back to the right side by a pushing force provided by a spring (not shown) or by means of the high pressure applied on the switch-side surface 5047.

In FIG. 6, the switch device 504 also serves as a relief valve. Even when the switch device 504 is in the closed state under the action of a high pressure from the control port 5043, a hydraulic force acting on the switch-side surface 5047 might also become greater than that acting on the control-side surface 5046 in some operating conditions due to excessive pressure in the cavity 5053 or the second passage 5042 caused by excessive throttling. Consequently, the valve spool 5044 is driven to the right to open the switch device 504, thus obtaining a relief effect to properly control the upstream snubbing pressure. This relief effect may take place temporarily, and after the upstream snubbing pressure gets controlled and the forces get balanced owing to the relief, the switch device 504 will revert to the closed state.

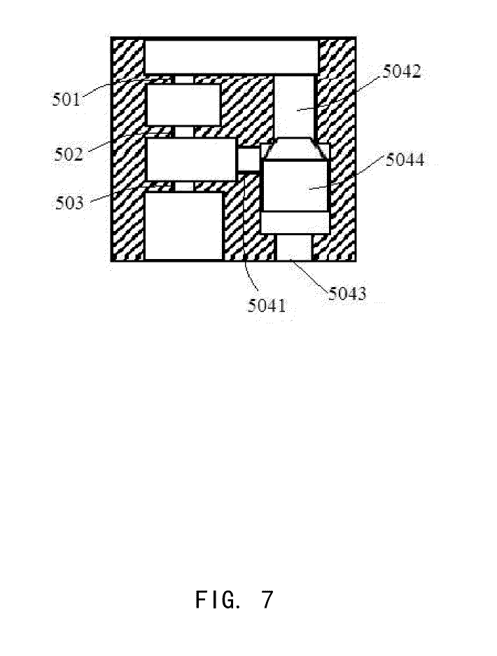

Referring to FIG. 4 and FIG. 7 together, FIG. 7 shows another structure of the variable throttle device shown in FIG. 4. In FIG. 7, the valve spool 5044 is disposed vertically, and the control port 5043 is formed on the bottom surface of the base body 1201. In this figure, the valve spool 5044 is in the closed state, and it moves downward by means of the gravity when no pressure is supplied to the control port 5043 situated at the bottom, or by a spring (not shown) that supplies a pushing force, or by a relatively high pressure upstream.

In FIGS. 6 and 7, when the valve spool 5044 is closed, the switch device 504 is not short-circuited and the fluid flows through the three throttle orifices 501, 502, 503. On the other hand, when the valve spool 5044 is opened, the switch device 504 is short-circuited and the fluid mainly flows through the throttle orifice 503 as well as the first passage 5041 and the second passage 5042, so the fluid can flow easily.

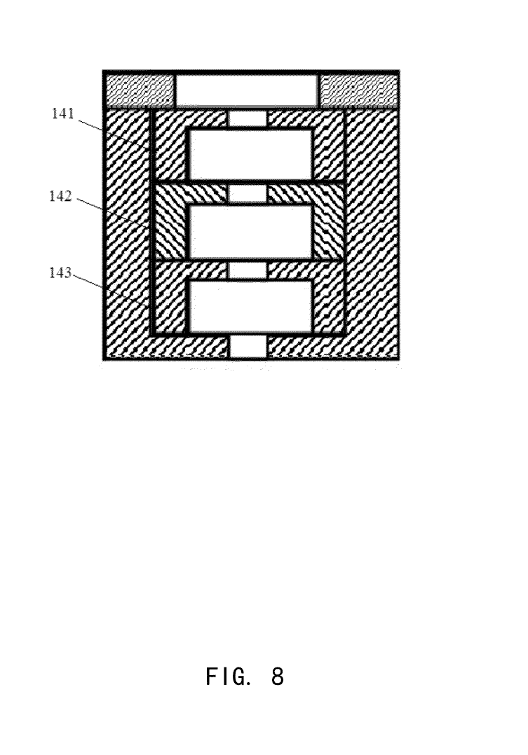

The variable throttle device shown in both FIG. 3 and FIG. 4 comprises a structure in which three fixed throttle orifices are connected in series. In addition to the structure shown in FIGS. 6 and 7 in which the three fixed throttle orifices are formed in the base body, FIG. 8 provides another structure. To make the valve seating velocity less sensitive to the temperature, the throttle orifices shall not be formed into an elongate form as far as possible. Because a turbulence tends to occur in the fluid, the flow rate passing through a sharp edge orifice is directly proportional to a square root of the pressure drop across the sharp edge orifice, and the valve seating velocity shall be insensitive to the temperature and the viscosity, and the throttle orifices shall be formed as sharp edge orifices as far as possible and at least be short orifices. When being applied in a gasoline engine valve control system, the throttle orifices may be very small (i.e., around 0.5 mm), so it is difficult to fabricate a cavity between the throttle orifices in a bulk material. Therefore, in FIG. 8, throttle orifice units 141, 142, 143 that are pre-fabricated are stacked on each other to form three fixed throttle orifice connected in series. In other embodiments, each of the throttle orifice units may be further divided into a sheet having a throttle orifice and a gasket that is relatively thick (not shown), and the gasket has an outer diameter equal to that of the sheet and an inner diameter much greater than that of the throttle orifice.

As can be summarized from the first to the third embodiments, the present disclosure provides a variable throttle device that comprises at least two fixed throttle orifices and one switch device. The at least two fixed throttle orifices are connected in series, and the switch device is connected parallel to at least one of the at least two fixed throttle orifices so that the switch device can be selectively closed to maintain the throttling function of the at least one fixed throttle orifice, or be opened to bypass the throttling function of the at least one fixed throttle orifice. By connecting the throttle orifices in series, an increased throttling resistance can be obtained to reduce the flow when the total pressure difference remains unchanged and, therefore, the piston or valve seating velocity can be reduced. When the switch device is opened to bypass the fixed throttle orifice(s) connected in parallel therewith, the throttling resistance can be reduced to increase the piston or valve seating velocity.

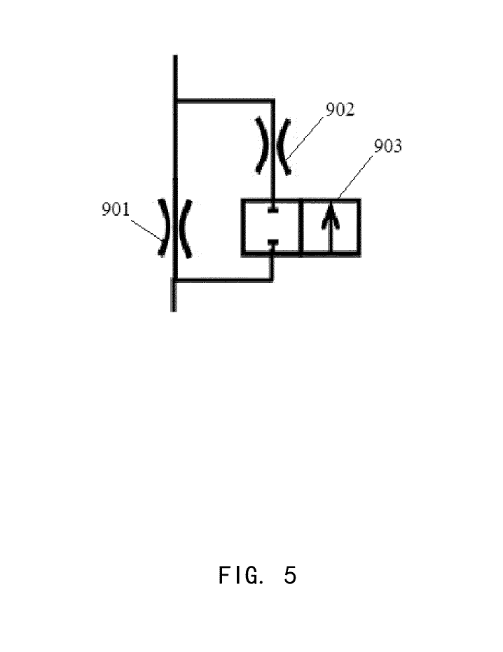

Referring further to FIG. 5, in a fourth embodiment, the variable throttle device comprises two fixed throttle orifices 901, 902 connected in parallel and one switch device 903. The switch device 903 is connected in series with one of the fixed throttle orifices 902. When the switch device 903 is in the closed state, the parallel connection is not effective; and when the switch device 903 is in the opened state, the parallel connection is effective, reducing the throttling resistance.

Correspondingly, the fourth embodiment may be modified as follows. The fixed throttle orifice 901 that is not connected in series with the switch device 903 may be replaced by two or more fixed throttle orifices connected in series (not shown), and the fixed throttle orifice 902 that is connected in series with the switch device 903 may be replaced by two or more fixed throttle orifices connected in series (not shown).

As can be summarized from the fourth embodiment and the modification thereof, the present disclosure provides a variable throttle device, which comprises at least two throttle passages connected in parallel and one switch device. Each of the throttle passages has one or more fixed throttle orifices connected in series, and the switch device is connected in series with at least one of the throttle passages to selectively open or close the at least one throttle passage. When the fixed throttle orifices of the throttle passages connected in parallel are all opened, a decreased throttling resistance can be obtained to increase the flow when the total pressure difference remains unchanged and, therefore, the piston or valve seating velocity can be increased.

Apart from being driven or controlled by the control pressure, the valve spool in the aforesaid embodiments may also be controlled in other ways, including by an electromagnetic force. In a system having a plurality of variable throttle devices, each of the variable throttle devices may have its own or separate control structure, or the plurality of variable throttle devices may be commonly controlled by a single control structure. For example, the control port pressure of switch devices of variable throttle devices in a control system for all the intake valves or for all the intake and exhaust valves may be controlled by a single two-position three-way solenoid valve (not shown) in an engine.

The numbers of fixed throttle orifices described in the aforesaid embodiments are only provided for illustration, and the present disclosure is not limited thereto.

The switch devices in the aforesaid embodiments may be implemented by short-circuit switches.

As can be summarized from the above embodiments, the present disclosure provides a variable throttle device that comprises at least two fixed throttle orifices and at least one switch device, and the at least one switch device is connected with at least one of the fixed throttle orifices. The at least one switch device may also serve as an relief valve which, when the fluid is excessively throttled, can be opened by the excessive upstream pressure to reduce the throttling level. The present disclosure is advantageous in that it is simple in structure, allows for stable control and has a low cost.

Specifically, in an aspect, a variable throttle device comprises at least two fixed throttle orifices and one switch device, wherein the at least two fixed throttle orifices are connected in series, and the switch device is connected in parallel with at least one of the at least two fixed throttle orifices so that the switch device can be selectively closed to maintain the throttling function of the at least one fixed throttle orifice or be opened to bypass the throttling function of the at least one fixed throttle orifice. In another aspect, a variable throttle device comprises at least two throttle passages and one switch device, wherein each of the at least two throttle passages has at least one fixed throttle orifice or a plurality of fixed throttle orifices connected in series, the at least two throttle passages are connected in parallel, and the switch device is connected in series with at least one of the throttle passages to selectively open or close the at least one throttle passage.

According to the above descriptions, the variable throttle device of the present disclosure uses a plurality of fixed throttle orifices connected in series or in parallel to increase or decrease the throttling resistance and particularly to make improvement on the design or performance shortcomings or limitations of using a single fixed throttle orifice;

and the variability is achieved by means of the on-off control of the switch device so that the throttling requirements under different operating conditions can be satisfied and the instability and high cost associated with the popular proportional control technologies can be avoided. In applications of automobile engine valve control, the throttling requirements mean that desired valve seating velocities shall be achieved under different operating conditions such as engine speed.

What is described above are only embodiments of the present disclosure, but are not intended to limit the present disclosure in any form. Although the present disclosure has been described above with reference to the embodiments thereof, these embodiments are not intended to limit the present disclosure. People skilled in the art can make slight alterations or modifications as equivalent embodiments on the basis of the above disclosures without departing from the scope of the present disclosure. However, any alterations, equivalent changes and modifications made to the above embodiments according to the technical spirits of the present disclosure and without departing from the scope of the present disclosure shall all be covered within the scope of the present disclosure.

What is claimed is:

1. A variable throttle device, comprising
at least two fixed throttle orifices and one switch device; wherein
the at least two fixed throttle orifices are connected in series; and
the switch device is connected in parallel with at least one of the at least two fixed throttle orifices, so that the switch device can be selectively closed and opened respectively to maintain and bypass the throttling function of the at least one of the at least two fixed throttle orifices.

2. The variable throttle device of any of claim 1, further comprising
a base body; wherein
the switch device further comprises, within the base body, a first passage, a second passage, a control port and a valve spool;
the valve spool has a control-side surface and a switch-side surface;
the valve spool is disposed in a space that communicates with the first passage, the second passage and the control port;
the switch-side surface of the valve spool is disposed to face toward one of the first passage and the second passage; and
the control-side surface of the valve spool is disposed to face toward the control port.

3. The variable throttle device of claim 2, wherein the valve spool is disposed vertically, thereby facilitating opening of the switch device by the gravity of the valve spool.

4. The variable throttle device of any of claim 1, wherein the fixed throttle orifices comprise throttle orifice units.

5. The variable throttle device of claim 4, wherein the throttle orifice units comprise sheets with throttle orifices.

6. The variable throttle device of claim 5, wherein a gasket is sandwiched between every two adjacent sheets, and the gasket has an outer diameter equal to that of the sheets and an inner diameter much greater than the throttle orifices.

7. The variable throttle device of any of claim 1, wherein the fixed throttle orifices have a diameter ranging between 0.50 mm and 1.0 mm.

8. A variable throttle device, comprising
at least two throttle passages and one switch device; wherein
each of the at least two throttle passages has at least one fixed throttle orifice, connected in series when more than one fixed throttle orifice;
the at least two throttle passages are connected in parallel; and
the switch device is connected in series with one of the at least two throttle passages, thereby selectively opening and closing the one of the at least two throttle passages.

9. The variable throttle device of any of claim 8, further comprising
a base body; wherein
the switch device further comprises, within the base body, a first passage, a second passage, a control port and a valve spool;
the valve spool has a control-side surface and a switch-side surface;
the valve spool is disposed in a space that communicates with the first passage, the second passage and the control port;
the switch-side surface of the valve spool is disposed to face toward one of the first passage and the second passage; and
the control-side surface of the valve spool is disposed to face toward the control port.

10. The variable throttle device of claim 9, wherein the valve spool is disposed vertically, thereby facilitating opening of the switch device by the gravity of the valve spool.

11. The variable throttle device of any of claim 8, wherein the fixed throttle orifices comprise throttle orifice units.

12. The variable throttle device of claim 11, wherein the throttle orifice units comprise sheets with throttle orifices.

13. The variable throttle device of claim 12, wherein a gasket is sandwiched between every two adjacent sheets, and the gasket has an outer diameter equal to that of the sheets and an inner diameter much greater than the throttle orifices.

14. The variable throttle device of any of claim 8, wherein the fixed throttle orifices have a diameter ranging between 0.50 mm and 1.0 mm.
